(19) United States
(12) Patent Application Publication
(10) Pub. No.: US 2012/0129682 A1
(43) Pub. Date: May 24, 2012

(54) METHOD OF FABRICATING NANOWIRE POROUS MEDIUM AND NANOWIRE POROUS MEDIUM FABRICATED BY THE SAME

(75) Inventors: Yong Ju YUN, Daejeon (KR); Han Young YU, Daejeon (KR); Yark Yeon KIM, Daejeon (KR); Won Ick JANG, Daejeon (KR)

(73) Assignee: Electronics and Telecommunications Research Institute, Daejeon (KR)

(21) Appl. No.: 13/288,198

(22) Filed: Nov. 3, 2011

(30) Foreign Application Priority Data
Nov. 23, 2010 (KR) 10-2010-0116816

(51) Int. Cl. B01J 20/30; B01J 20/28; B82Y 30/00; B82Y 40/00

(52) U.S. Cl. 502/5; 502/401; 502/11; 502/402; 502/404; 977/762; 977/902

(57) ABSTRACT

Provided is a method of fabricating of a nanowire porous medium and a medium formed by the method. In this method, water and organic solvent are mixed and stirred to form a large amount of bubbles, and the bubbles are used such that porosity can be formed more easily and in a more amount. Therefore, the nanowire porous medium can be fabricated more easily and simply. Also, in the nanowire porous medium according to the inventive concept, absorption capacity is increased by containing nanowires, and flexibility and durability are increased by containing a polymer.

### CROSS-REFERENCE TO RELATED APPLICATIONS

This U.S. non-provisional patent application claims priority under 35 U.S.C. §119 of Korean Patent Applications No. 10-2010-0116816, filed on Nov. 23, 2010, the entire contents of which are hereby incorporated by reference.

### BACKGROUND

The present disclosure herein relates to a method of fabricating a nanowire porous medium and to a nanowire porous medium fabricated by the method.

Nanowires have larger surface area than typical materials such that nanowires have excellent absorption capacity with respect to materials such as gases, ions and atoms and can selectively absorb specific materials by surface treatment. Based on these advantages, many researches and developments are being actively progressed in order to apply nanowires to high functional•high efficiency filter materials, energy storage media materials, reinforcing agents of composite materials or the like by recently fabricating the nanowires into a film of more than few cm or a structure having a three-dimensional shape.

However, in spite of having many advantages as described above, products applied with the nanowires have not come into wide use because of complex manufacturing processes, low durability and high-priced materials.

### SUMMARY

The present disclosure provides a method of fabricating a nanowire porous medium which can be fabricated by easier and simpler processes.

The present disclosure also provides a nanowire porous medium having excellent functionality and durability.

Embodiments of the inventive concept provide methods of fabricating a nanowire porous medium including: preparing a nanowire solution and a polymer solution, respectively; mixing the nanowire solution with the polymer solution to form a first mixed solution; mixing and stirring water and an organic solvent to form a second mixed solution including a large amount of bubbles; mixing and stirring the first and second mixed solutions to form a third mixed solution; and forming a nanowire porous medium by freeze-drying the third mixed solution.

In some embodiments, the above method may further include performing a surface treatment process with respect to the nanowire porous medium. The performing of the surface treatment process may use plasma.

In other embodiments of the inventive concept, a nanowire porous medium includes a polymer and nanowires. In one example, the nanowire porous medium according to the inventive concept includes a vanadium pentoxide (V₂O₅) and polyvinyl alcohol.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a flowchart illustrating a method of fabricating a nanowire porous medium of the inventive concept;

FIG. 2 is a perspective view of a nanowire porous medium fabricated according to the inventive concept;

FIG. 3 is a photograph showing an entire nanowire porous medium fabricated according to an embodiment of the inventive concept;

FIG. 4A is an enlarged photograph of a portion of the nanowire porous medium of FIG. 3;

FIG. 4B is an enlarged photograph of the portion of FIG. 4A;

FIG. 4C is an enlarged photograph of a portion of a nanowire porous medium fabricated according to a comparative example; and

FIG. 4D is an enlarged photograph of the portion of FIG. 4C.

### DETAILED DESCRIPTION OF THE EMBODIMENTS

Preferred embodiments of the present invention will be described below in more detail. The invention may, however, be embodied in many different forms and should not be construed as being limited to the embodiments set forth herein; rather, these embodiments are provided so that this disclosure will be thorough and complete, and will fully convey the concept of the invention to those skilled in the art.

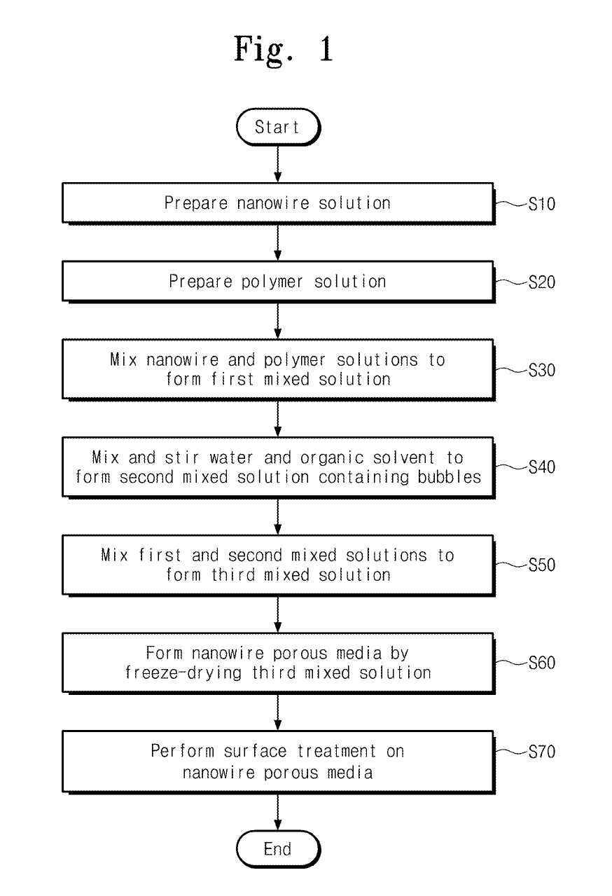

FIG. 1 is a flowchart illustrating a method of fabricating a nanowire porous medium of the inventive concept.

Referring to FIG. 1, in first step S10, a nanowire solution is first prepared. The first step S10 may be performed by mixing and stirring nanowires, an ion exchange resin and water. The nanowires, the ion exchange resin and the water may be mixed and stirred for about 48 hours to about 96 hours. The nanowires may be at least one selected from the group consisting of insulator, semiconductor and metal. The insulator may be silicon oxide (SiO₂) or titanium oxide (TiO₂). The semiconductor may be at least one selected from the group consisting of silicon (Si), germanium (Ge), gallium arsenide (GaAs), gallium nitride (GaN), gallium phosphorous (GaP), indium phosphorous (InP), zinc sulfide (ZnS), zinc oxide (ZnO), indium oxide (In₂O₃), tin oxide (SnO), carbon nano tube, ammonium metavanadate (NH₄VO₃), and vanadium oxide (V₂O₅). The metal may be at least one selected from the group consisting of gold (Au), silver (Ag), aluminum (Al), nickel (Ni), platinum (Pt), lead (Pb), magnesium (Mg), titanium (Ti), lithium (Li), chromium (Cr), iron (Fe), cerium (Ce), molybdenum (Mo), tin (Sn), beryllium (Be), vanadium (V), cobalt (Co), copper (Cu), zinc (Zn), niobium (Nb), indium (In), tantalum (Ta), tungsten (W), and iridium (Ir).

Continuously, referring to FIG. 1, in second step S20, a polymer solution is prepared. The polymer solution may be processed by mixing and stirring a polymer and water. The polymer may be at least one selected from the group consisting of acrylonitrile butadiene styrene (ABS), polymethyl methacrylate (PMMA), celluloid, cellulose acetate, cycloolefin copolymer, ethylene vinyl acetate (EVA), ethylene vinyl alcohol (EVOH), polytetrafluoroethylene (PTFE), liquid crystal polymer, polyacetal, polyacrylates, polyacrylonitrile, polyamide-imide, polybutylene, polyetherimide, polyethylene (PE), polypropylene (PP), polystylene (PS), polyvinyl alcohol (PVA), polyvinyl chloride (PVC), polyvinylidene chloride (PVDC), polyethylene terephthalate (PET), polyamides (PA, nylon), polyester (PES), polyurethanes (PU), polycarbonate (PC), and polyimide.

Continuously, referring to FIG. 1, in third step S30, the nanowire solution and the polymer solution are mixed to form a first mixed solution. In the first mixed solution, the nanowire solution and the polymer solution may be mixed in a volume ratio of about 0.5:1-2:1.

Continuously, in fourth step S40, water and organic solvent are mixed and stirred to form a second mixed solution including bubbles. The organic solvent may be at least one selected from the group consisting of acetic acid (C₂H₄O₂), aceton (C₃H₆O), acetonitrile (C₂H₃N), benzene (C₆H₆), 1-butanol (C₄H₁₀O), 2-butanol (C₄H₁₀O), 2-butanone (C₄H₈O), t-butyl alcohol (C₄H₁₀O), carbon tetrachloride (CCl₄), chlorobenzene (C₆H₅Cl), chloroform (CHCl₃), cyclohexane (C₆H₁₂), 1,2-dichloroethane (C₂H₄Cl₂), diethyl ether (C₄H₁₀O), diethylene glycol (C₄H₁₀O₃), diglyme (C₆H₁₄O₃), 1,2-dimethoxy-ethane (C₄H₁₀O₂), dimethylether (C₂H₆O), dimethyl-formamide (DMF, C₃H₇NO), dimethyl sulfoxide (DMSO, C₂H₆OS), dioxane (C₄H₈O₂), ethanol (C₂H₆O), ethyl acetate (C₄H₈O₂), ethylene glycol (C₂H₆O₂), glycerin (C₃H₈O₃), heptane (C₇H₁₆), hexamethylphosphoramide (HMPA, C₆H₁₈N₃OP), hexamethylphosphorous triamide (HMPT, C₆H₁₈N₃P), hexane (C₆H₁₄), methanol (CH₄O), methyl t-butyl ether (MTBE, C₅H₁₂O), methylene chloride (CH₂Cl₂), N-methyl-2-pyrrolidinone (NMP, CH₅H₉NO), nitromethane (CH₃NO₂), pentane (C₅H₁₂), petroleum ether (ligroine), 1-propanol (C₃H₈O), 2-propanol (C₃H₈O), pyridine (C₅H₅N), tetrahydrofuran (THF, C₄H₈O), toluene (C₇H₈), triethyl amine (C₆H₁₅N), o-xylene (C₈H₁₀), m-xylene (C₈H₁₀), and p-xylene (C₈H₁₀). The fourth step may be performed using a stirrer and/or a mixer.

Continuously, in fifth step S50, the first mixed solution and the second mixed solution are mixed to form a third mixed solution.

Then, in sixth step S60, a nanowire porous medium is formed by freeze-drying the third mixed solution. For this purpose, the third mixed solution is first put into a container and a freeze-drying process may be performed. The nanowire porous medium may have various shapes depending on the shapes of the container. For example, the nanowire porous medium may have a shape like a film or a bulk. The step of the freeze-drying of the third mixed solution may be performed under a pressure of about 0-10 mTorr. Therefore, the nanowire porous medium including the nanowires and the polymer may be formed by removing solvent in the third mixed solution.

Subsequently, in seventh step S70, surface treatment may be performed on the nanowire porous medium in order to selectively attach a radical having a property like hydrophilic or hydrophobic. The surface treatment may be performed using plasma.

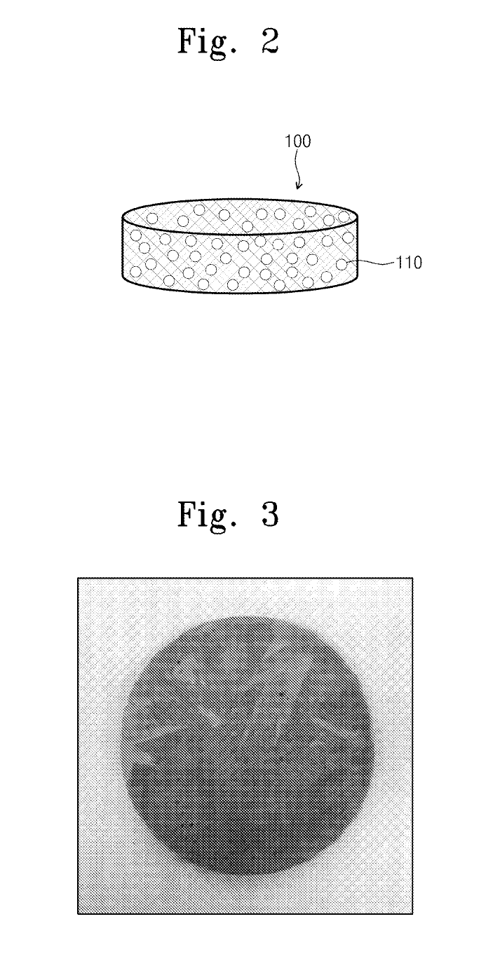

FIG. 2 is a perspective view of a nanowire porous medium fabricated according to the inventive concept.

Referring to FIG. 2, a nanowire porous medium 100 manufactured according to the inventive concept is composed of a mixture of nanowires and a polymer, and pores 110 formed by organic solvent are uniformly distributed on a surface or inside of the nanowire porous medium. The nanowire porous medium may have a surface area of about 1 mm² to about 1 m². The nanowire porous medium may be used for various purposes according to shapes thereof such as filters having a film shape, or absorbents, energy storage medium materials, reinforcing agents of composite materials and the like.

### Exemplary Embodiment

First step: First, a nanowire solution was prepared. About 0.4 g of ammonium meta-vanadate (NH₄VO₃) was prepared as nanowires. After putting 0.4 g of ammonium meta-vanadate (NH₄VO₃) and 4 g of an ion-exchange resin into about 80 ml of distilled water, they were mixed sufficiently using a stirrer. Although it showed a yellow color in the beginning, the solution of vanadium pentoxide nanowire having a reddish-brown color was prepared after 72 hours.

Second step: A polymer solution was prepared. About 2 g of polyvinyl alcohol was prepared as a polymer. After mixing this with about 98 ml of distilled water, they are sufficiently mixed for about 1 hour using the stirrer at 60° C. Although it showed a white color in the beginning, the polymer solution of polyvinyl alcohol having clear color was prepared after about 1 hour.

Third step: a first mixed solution was prepared by mixing about 100 ml of the nanowire solution with about 100 ml of the polymer solution and stirring for about 1 hour with the stirrer.

Fourth step: a second mixed solution was prepared by mixing about 90 ml of distilled water with about 10 ml of tetrahydrofuran (THF). The second mixed solution was sufficiently mixed for about 30 minutes using the stirrer and a mixer in order to form a large amount of bubbles in the second mixed solution.

Fifth step: a third mixed solution was made by mixing about 200 ml of the first mixed solution with about 100 ml of the second mixed solution for about 30 minutes by the stirrer and the mixer.

Sixth step: the third mixed solution was put into a container having a circular shape such as a chalet, and put the container in a refrigerator maintaining at about 5° C. to freeze. Then, it was frozen for about 1 day. The container was put in a freeze-dryer maintaining at a temperature of about −80° C. and a nanowire porous medium containing vanadium pentoxide (V₂O₅) and polyvinyl alcohol was fabricated by drying.

The surface treatment of the seventh step was not performed in the present exemplary embodiment.

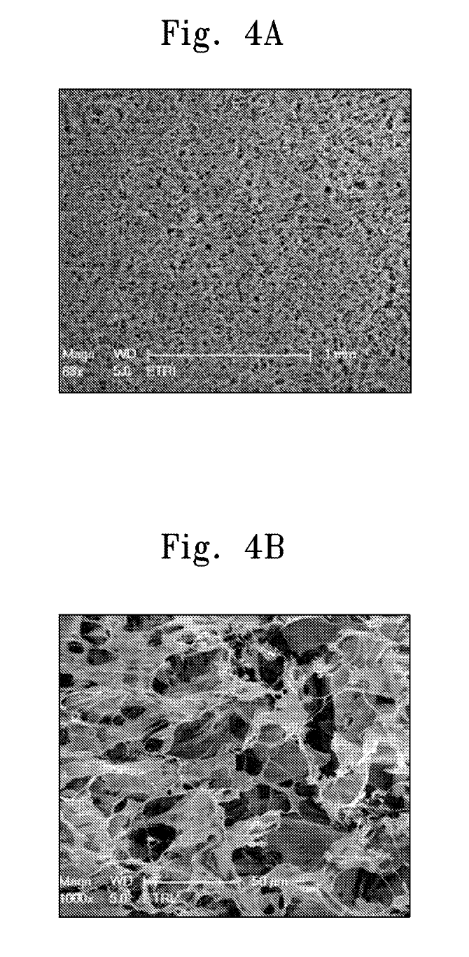

The nanowire porous medium fabricated according to the present exemplary embodiment is shown in FIG. 3. Referring to FIG. 3, the size of the fabricated nanowire porous medium was a diameter of about 10 cm and a thickness of about 0.5 cm. The weight of the nanowire porous medium was about 0.2 g.

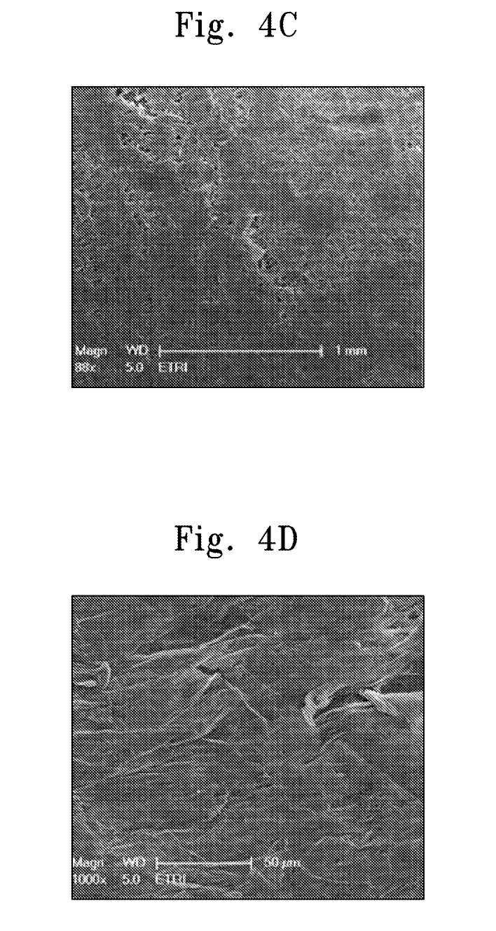

FIG. 4A is an enlarged photograph of a portion of the nanowire porous medium of FIG. 3. FIG. 4B is an enlarged photograph of the portion of FIG. 4A.

Referring to FIGS. 4A and 4B, it can be understood that pores having about 10-50 μm size are uniformly formed on the entire surface of the fabricated nanowire porous medium, and it can be confirmed that the nanowires are densely distributed between the pores.

Meanwhile, a comparative experiment was performed to examine effects caused by an addition of organic solvent in the fabricating method of the nanowire porous medium according to the inventive concept. In the comparative experiment, THF, which was the organic solvent in the above exemplary embodiment, was not added, and the rest processes were the same as the exemplary embodiment.

A portion of a nanowire porous medium fabricated according to a comparative example is enlarged and shown in FIG. 4C. FIG. 4D is an enlarged photograph of the portion of FIG. 4C.

Referring to FIGS. 4C and 4D, it can be confirmed that pores were hardly formed on a surface of the nanowire porous medium fabricated according to the comparative example.

The nanowire porous medium containing vanadium pentoxide (V₂O₅) and polyvinyl alcohol, which was fabricated in the present exemplary embodiment, has excellent absorption capacity and durability in particular.

Likewise, a nanowire porous medium can be easily fabricated to a desired shape and size by the fabricating method of the nanowire porous medium according to the inventive concept. Also, the nanowire porous medium according to the inventive concept includes nanowires having a large surface area and a polymer having excellent durability, thereby enabling to be used in real life as filters or absorbents for removing contaminants or used in variety for the purposes of energy storage and structural reinforcement of composites, etc.

In a fabricating method of a nanowire porous medium according to the inventive concept, water and organic solvent are mixed and stirred to form a large amount of bubbles, and the bubbles are used such that porosity can be formed more easily and in a large quantity. Therefore, the nanowire porous medium can be fabricated more easily and simply. Also, the nanowire porous medium according to the inventive concept contains the nanowires that increase absorption capacity, and the polymer that increases flexibility and durability.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A method of fabricating a nanowire porous medium, the method comprising:
preparing a nanowire solution and a polymer solution, respectively;
mixing the nanowire solution with the polymer solution to form a first mixed solution;
mixing and stirring water and an organic solvent to form a second mixed solution comprising a large amount of bubbles;
mixing and stirring the first and second mixed solutions to form a third mixed solution; and
forming a nanowire porous medium by freeze-drying the third mixed solution.

2. The method of claim 1, further comprising performing a surface treatment process with respect to the nanowire porous medium.

3. The method of claim 2, wherein the performing of the surface treatment process uses plasma.

4. The method of claim 1, wherein the preparing of the nanowire solution comprises mixing and stirring nanowires, an ion exchange resin and water.

5. The method of claim 4, wherein the mixing and stirring of the nanowires, the ion exchange resin and the water are performed for about 48 hours to about 96 hours.

6. The method of claim 4, wherein the nanowires are at least one selected from the group consisting of an insulator, a semiconductor and a metal.

7. The method of claim 6, wherein the insulator is silicon oxide (SiO₂) or titanium oxide (TiO₂).

8. The method of claim 6, wherein the semiconductor is at least one selected from the group consisting of silicon (Si), germanium (Ge), gallium arsenide (GaAs), gallium nitride (GaN), gallium phosphorous (GaP), indium phosphorous (InP), zinc sulfide (ZnS), zinc oxide (ZnO), indium oxide (In₂O₃), tin oxide (SnO), carbon nano tube, ammonium metavanadate (NH₄VO₃), and vanadium oxide (V₂O₅).

9. The method of claim 6, wherein the metal is at least one selected from the group consisting of gold (Au), silver (Ag), aluminum (Al), nickel (Ni), platinum (Pt), lead (Pb), magnesium (Mg), titanium (Ti), lithium (Li), chromium (Cr), iron (Fe), cerium (Ce), molybdenum (Mo), tin (Sn), beryllium (Be), vanadium (V), cobalt (Co), copper (Cu), zinc (Zn), niobium (Nb), indium (In), tantalum (Ta), tungsten (W), and iridium (Ir).

10. The method of claim 1, wherein the preparing of the polymer solution comprises mixing and stirring a polymer and water.

11. The method of claim 10, wherein the polymer is at least one selected from the group consisting of acrylonitrile butadiene styrene (ABS), polymethyl methacrylate (PMMA), celluloid, cellulose acetate, cycloolefin copolymer, ethylene vinyl acetate (EVA), ethylene vinyl alcohol (EVOH), polytetrafluoroethylene (PTFE), liquid crystal polymer, polyacetal, polyacrylates, polyacrylonitrile, polyamide-imide, polybutylene, polyetherimide, polyethylene (PE), polypropylene (PP), polystylene (PS), polyvinyl alcohol (PVA), polyvinyl chloride (PVC), polyvinylidene chloride (PVDC), polyethylene terephthalate (PET), polyamides (PA, nylon), polyester (PES), polyurethanes (PU), polycarbonate (PC), and polyimide.

12. The method of claim 1, wherein the organic solvent is at least one selected from the group consisting of acetic acid (C₂H₄O₂), aceton (C₃H₆O), acetonitrile (C₂H₃N), benzene (C₆H₆), 1-butanol (C₄H₁₀O), 2-butanol (C₄H₁₀O), 2-butanone (C₄H₈O), t-butyl alcohol (C₄H₁₀O), carbon tetrachloride (CCl₄), chlorobenzene (C₆H₅Cl), chloroform (CHCl₃), cyclohexane (C₆H₁₂), 1,2-dichloroethane (C₂H₄Cl₂), diethyl ether (C₄H₁₀O), diethylene glycol (C₄H₁₀O₃), diglyme (C₆H₁₄O₃), 1,2-dimethoxy-ethane (C₄H₁₀O₂), dimethylether (C₂H₆O), dimethyl-formamide (DMF, C₃H₇NO), dimethyl sulfoxide (DMSO, C₂H₆OS), dioxane (C₄H₈O₂), ethanol (C₂H₆O), ethyl acetate (C₄H₈O₂), ethylene glycol (C₂H₆O₂), glycerin (C₃H₈O₃), heptane (C₇H₁₆), hexamethylphosphoramide (HMPA, C₆H₁₈N₃OP), hexamethylphosphorous triamide (HMPT, C₆H₁₈N₃P), hexane (C₆H₁₄), methanol (CH₄O), methyl t-butyl ether (MTBE, C₅H₁₂O), methylene chloride (CH₂Cl₂), N-methyl-2-pyrrolidinone (NMP, CH₅H₉NO), nitromethane (CH₃NO₂), pentane (C₅H₁₂), petroleum ether (ligroine), 1-propanol (C₃H₈O), 2-propanol (C₃H₈O), pyridine (C₅H₅N), tetrahydrofuran (THF, C₄H₈O), toluene (C₇H₈), triethyl amine (C₆H₁₅N), o-xylene (C₈H₁₀), m-xylene (C₈H₁₀), and p-xylene (C₈H₁₀).

13. The method of claim 1, wherein the nanowire solution and the polymer solution are mixed in a volume ratio of about 0.5:1-2:1 in the first mixed solution.

14. The method of claim 1, wherein the freeze-drying of the third mixed solution is performed under a pressure of about 0-10 mTorr.

15. A nanowire porous medium, comprising a vanadium pentoxide (V₂O₅) and polyvinyl alcohol.
